(19) United States
(12) Patent Application Publication
(10) Pub. No.: US 2026/0287706 A1
(43) Pub. Date: Sep. 24, 2026

(54) HYBRID 1D-2D PARTICLE FILTER FOR INDOOR POSITIONING

(71) Applicant: QUALCOMM Incorporated, San Diego, CA (US)

(72) Inventor: Benjamin TARLOW, Cambridge (GB)

(21) Appl. No.: 19/082,584

(22) Filed: Mar. 18, 2025

(51) Int. Cl. G01S 5/02; G01S 5/10

(52) U.S. Cl. CPC G01S 5/0269; G01S 5/10

(57) ABSTRACT

Determining a position of a user equipment (UE) in an environment, includes: determining potential positions for the UE in the environment that includes a first area with a first placement of obstacles and a second area with a second placement of obstacles different from the first placement; applying a 1D positioning filter to the potential positions based on the potential positions being in the first area, where the potential positions propagate in one dimension along edge(s) of a graph corresponding to the environment; applying a 2D positioning filter to the potential positions based on the potential positions being in the second area, where the plurality of potential positions propagate in two dimensions in one or more 2D planes in the graph corresponding to the environment; and determining the position of the UE in the environment based on the application of the 1D positioning filter or the 2D positioning filter.

### BACKGROUND

Devices, such as mobile devices, may move within an indoor environment that may include a mixture of structured areas and open areas based on the locations of various obstacles. In indoor navigation, positions of devices, such as mobile devices, may be determined using terrestrial-based positioning signals, such as one or more radio frequency (RF) modalities (e.g., WiFi®—Received Signal Strength Indication (RSSI) Round Trip Time (RTT), and Bluetooth®—low energy (BLE)). The mobile device may be equipped with sensors, such as an inertial measurement unit (IMU), which provide measurement (e.g., relative turn angle (RTA), heading, step count, etc.), from which movements of the mobile device may be tracked.

### SUMMARY

An example method for determining a position of a user equipment (UE) in an environment, includes: determining a plurality of potential positions for the UE in the environment, where the environment includes a first area with a first placement of obstacles and a second area with a second placement of obstacles different from the first placement of obstacles; applying a one-dimensional (1D) positioning filter to the plurality of potential positions based on the plurality of potential positions being in the first area, where the plurality of potential positions propagate in one dimension along one or more edges of a graph corresponding to the environment; applying a two-dimensional (2D) positioning filter to the plurality of potential positions based on the plurality of potential positions being in the second area, where the plurality of potential positions propagate in two dimensions in one or more 2D planes in the graph corresponding to the environment; and determining the position of the UE in the environment based on the application of the 1D positioning filter or the 2D positioning filter.

An example UE for determining a position of the UE in an environment, includes: one or more memories; and one or more processors communicatively coupled to the one or more memories, the one or more processors being configured to: determine a plurality of potential positions for the UE in the environment, where the environment includes a first area with a first placement of obstacles and a second area with a second placement of obstacles different from the first placement of obstacles; apply a one-dimensional (1D) positioning filter to the plurality of potential positions based on the plurality of potential positions being in the first area, where the plurality of potential positions propagate in one dimension along one or more edges of a graph corresponding to the environment; apply a two-dimensional (2D) positioning filter to the plurality of potential positions based on the plurality of potential positions being in the second area, where the plurality of potential positions propagate in two dimensions in one or more 2D planes in the graph corresponding to the environment; and determine the position of the UE in the environment based on the application of the 1D positioning filter or the 2D positioning filter.

An example UE for determining a position of the UE in an environment, includes: means for determining a plurality of potential positions for the UE in the environment, where the environment includes a first area with a first placement of obstacles and a second area with a second placement of obstacles different from the first placement of obstacles; means for applying a one-dimensional (1D) positioning filter to the plurality of potential positions based on the plurality of potential positions being in the first area, where the plurality of potential positions propagate in one dimension along one or more edges of a graph corresponding to the environment; means for applying a two-dimensional (2D) positioning filter to the plurality of potential positions based on the plurality of potential positions being in the second area, where the plurality of potential positions propagate in two dimensions in one or more 2D planes in the graph corresponding to the environment; and means for determining the position of the UE in the environment based on the application of the 1D positioning filter or the 2D positioning filter.

An example non-transitory, processor-readable storage medium includes processor-readable instructions for determining a position of a user equipment (UE) in an environment, the processor-readable instructions to cause one or more processors to: determine a plurality of potential positions for the UE in the environment, where the environment includes a first area with a first placement of obstacles and a second area with a second placement of obstacles different from the first placement of obstacles; apply a one-dimensional (1D) positioning filter to the plurality of potential positions based on the plurality of potential positions being in the first area, where the plurality of potential positions propagate in one dimension along one or more edges of a graph corresponding to the environment; apply a two-dimensional (2D) positioning filter to the plurality of potential positions based on the plurality of potential positions being in the second area, where the plurality of potential positions propagate in two dimensions in one or more 2D planes in the graph corresponding to the environment; and determine the position of the UE in the environment based on the application of the 1D positioning filter or the 2D positioning filter.

### BRIEF DESCRIPTION OF THE DRAWINGS

FIG. 1 illustrates an example floorplan for an indoor environment.

FIG. 2 illustrates an example user equipment (UE).

FIG. 3 illustrates an example of the user equipment of FIG. 2.

FIG. 4A illustrates an example graph for the indoor environment of FIG. 1, with the graph overlaid on the floorplan for the indoor environment.

FIG. 4B illustrates the example graph in FIG. 4A without an overlay on an indoor environment.

FIG. 5 illustrates the example graph in FIG. 4B with example particles.

FIG. 6 illustrates a method for determining a position of a UE in an environment.

FIG. 7 illustrates a method for determining a position of a UE in a first area of the environment with a first placement of obstacles.

FIG. 8 illustrates a method for applying the 1D positioning particle filter.

FIG. 9 illustrates a method for determining a position of a UE in a second area of an environment with a second placement of obstacles different from the first placement of obstacles.

FIG. 10 illustrates a method for applying a 2D positioning particle filter.

FIG. 11 illustrates a method for determining a position of a UE in an environment in a hybrid area.

### DETAILED DESCRIPTION

Techniques are discussed herein for performing a positioning operation indoors to estimate a location of a user equipment (UE). An indoor environment may be represented by a graph of path vectors of movement by a UE. The graph may include one or more first areas with one or more edges representing one or more pathways through one or more structured spaces, one or more second areas representing open pathways through spaces with less structure, and one or more hybrid areas representing one or more pathways through spaces between the structured spaces and the open spaces. A one-dimensional (1D) positioning filter may be applied to allow movement in one dimension in the one or more first areas. A two-dimensional (2D) positioning filter may be applied to allow movement in two dimensions in the one or more second areas. A combination of the 1D positioning filter and the 2D positioning filter may be applied to allow movement in one dimension and/or two dimensions in the one or more hybrid areas. A position of the UE may be determined based on the application of the 1D positioning filter and/or the 2D positioning filter. By reducing movement in one dimension in the one or more first areas, the processing load to estimate the position of the UE may be reduced. Allowing movement in a combination of one and two dimensions in the one or more hybrid areas may smooth the transition between the 1D positioning filter and the 2D positioning filter. These are examples, and other examples may be implemented.

Particular aspects of the subject matter described in this disclosure can be implemented to realize one or more of the following potential advantages. Items and/or techniques described herein may provide one or more of the following capabilities, and possibly one or more other capabilities not mentioned. Other capabilities may be provided and not every implementation according to the disclosure must provide any, let alone all, of the capabilities discussed.

Navigational or other location-based services may rely at least partially on determining at least an estimated position of a user equipment (UE). Positioning strategies that are effective in outdoor environments, which may utilize satellite positioning system (SPS) signals or satellite imagery, may be inadequate for indoor environments. Performing a positioning operation indoors to estimate a location of a UE may involve different techniques or strategies as compared to those that may be used outdoors. Within indoor environments, UEs may attempt to effectuate indoor positioning at least partly by processing signals transmitted from transmitters (e.g., wireless transmitter devices) that are located, for example, within an indoor environment at known locations. Examples of transmitters may include wireless transmitter devices that comport with a Wi-Fi access point protocol (e.g., IEEE 802.11), a Bluetooth protocol, a femtocell protocol, or any combination thereof.

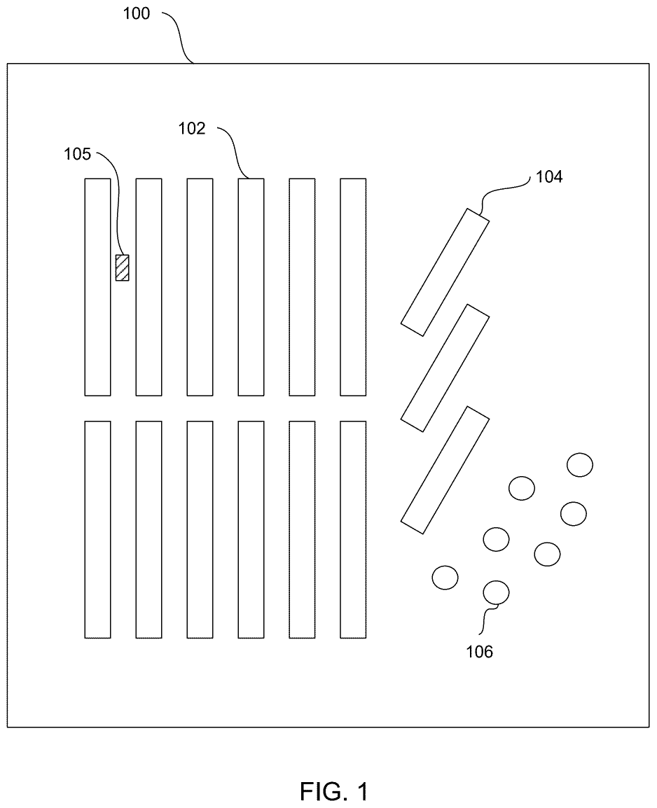

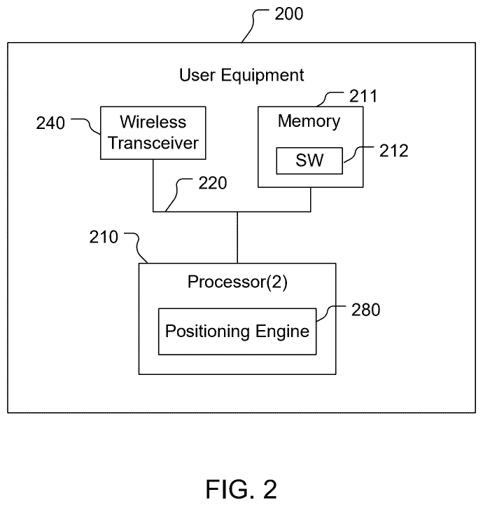

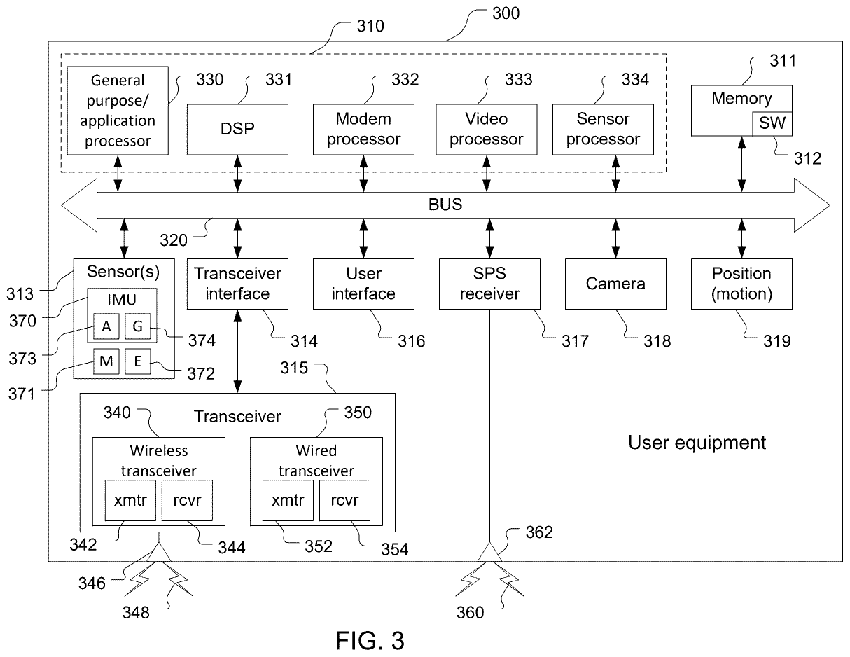

FIG. 1 illustrates an example floorplan for an indoor environment. The indoor environment 100 may include various obstacles that form areas with structured spaces, such as aisles and walkways formed by shelves 102, and areas that are more open or have less structure, such as that formed by a mixture of shelves 104 and displays 106. A user carrying a UE 105 may travel within the indoor environment 100. To provide to a user of the UE 105 a location-based service via a navigational application, an estimated position of the UE 105 within the indoor environment 100 may be determined by a positioning engine of the UE 105. The UE 105 is described further below with reference to FIGS. 2 and 3.

In general, the UE 105 may be any wireless communication device (e.g., a mobile phone, router, tablet computer, laptop computer, consumer asset tracking device, Internet of Things (IoT) device, etc.). A UE 105 may be mobile or may (e.g., at certain times) be stationary. As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. The UE 105 may be embodied by any of a number of types of devices including but not limited to printed circuit (PC) cards, compact flash devices, external or internal modems, wireless or wireline phones, smartphones, tablets, consumer asset tracking devices, asset tags, and so on. The UE 105 may comprise and/or may be referred to as a device, a mobile device, a wireless device, or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, virtual reality headsets, augmented reality glasses, or some other portable or moveable device. The UE 105 supports wireless communication with the target object 102 using one or more Radio Access Technologies (RATs) such as IEEE 802.11 WiFi® (also referred to as Wi-Fi®), Bluetooth® (BT), Ultra-wideband (UWB), etc., that may be used by wireless ranging techniques.

The position of the UE 105 may be referred to as a position estimate, or position fix, and may be geographic, e.g., location coordinates for the UE 105 in three-dimensional space. A position of the UE 105 may be expressed as an area or volume within which the UE 105 is expected to be located with some probability or confidence level (e.g., 67%, 95%, etc.). A position of the UE 105 may be expressed as a relative position comprising, for example, a distance and direction from a reference position. The relative position may be expressed as relative coordinates (e.g., ΔX, ΔY, and ΔZ coordinates) defined relative to the reference position. In the description contained herein, the use of the term “position” may comprise any of these variants unless indicated otherwise.

As a user travels within an indoor environment while carrying the UE 105, position estimates of the UE 105 may be at least partially determined using, for example, one or more signals transmitted from at least one transmitter. A UE 105 may measure characteristics of signals received from one or more transmitters. Such characteristics may include received signal strength indicator or indication (RSSI) measurements, round trip time (RTT) measurements, round trip delay (RTD) measurements, time of arrival (TOA) measurements, angle of arrival (AOA) measurements, or combinations thereof. Using measurements of received wireless signals along with techniques that are known in the art (e.g., trilateration), a location of the UE 105 may be estimated. With trilateration, for example, the UE 105 use well known techniques to obtain a position fix from ranges to multiple transmitters that are positioned at known locations. Ranges to transmitters may be measured based, at least in part, on received wireless signal characteristics (e.g., RSSI, RTT, RTD, TOA, AOA, etc.).

Indirect mechanisms that may be used to determine an estimated location may comprise indirect measurements, predictive procedures, mobility models, or any combinations thereof. For example, a movement model may indicate a possible or likely movement pattern of the UE 105. Implementation of a movement model may include application of positional filtering, consideration of a likely speed of perambulation (e.g., a reasonable or maximum walking speed), or applying a smoothing procedure to a traveled path, etc., just to name a few examples. Other indirect mechanisms may indicate, for example, relative positional movement of a mobile device. Relative positional movement may be determined using one or more indirect measurements. Indirect measurements may be obtained from, by way of example only, one or more inertial sensors such as accelerometer(s), pedometer(s), compass(es), gyroscope(s), or any combination thereof. Additionally or alternatively, determination of a relative positional movement may use, by way of example only, at least one mobility model that considers average or maximum velocity of a pedestrian, a previous location, a previous velocity (e.g., a previous speed or a previous direction of travel, etc.), one or more probabilistic mechanisms, a path smoothing procedure, a path filtering procedure, or any combination thereof.

FIG. 2 illustrates an example user equipment 200. The UE 200 may be an example of UE 105. The UE 200 may comprise one or more processors 210, one or more memories 211 including software (SW) 212, and one or more wireless transceivers 240, although any of these devices may be referred to in the singular (e.g., the processor 210) while including one or more of the respective devices. The one or more processors 210 and the one or more memories 211 may be communicatively coupled to each other by a bus 220 (which may be configured, e.g., for optical and/or electrical communication). The transceiver 240 is configured for wireless communication using one or more RATs. The description herein may refer to the one or more processors 210 performing a function, but this includes other implementations such as where the one or more processors 210 executes software 212 (stored in the one or more memories 211) and/or firmware. The description herein may refer to the UE 200 performing a function as shorthand for one or more appropriate components (e.g., the one or more processors 210 and the one or more memories 211) of the UE 200 performing the function. The one or more processors 210 (possibly in conjunction with the one or more memories 211) may include a positioning engine 280. The positioning engine 280 may be configured to perform positioning operations (e.g., determine position information (e.g., measurements, pseudoranges, position estimates, etc.). The positioning engine 280 is discussed further below, and the description may refer to the one or more processors 210 generally, or the UE 200 generally, as performing any of the functions of the positioning engine 280, with the UE 200 being configured to perform the function(s).

FIG. 3 illustrates an example UE 300. The UE 300 may be an example of the UE 200 shown in FIG. 2. The UE 300 may comprise a computing platform including one or more processors 310, one or more memories 311 including software (SW) 312, one or more sensors 313, a transceiver interface 314 for the transceiver 315 that includes the wireless transceiver 340, a user interface 316, a camera 318, and a position device (PD) 319. The one or more processors 310, the one or more memories 311, the one or more sensors 313, the transceiver interface 314, the user interface 316, the camera 318, and the position device 319 may be communicatively coupled to each other by a bus 320 (which may be configured, e.g., for optical and/or electrical communication). The one or more processors 210 may include one or more intelligent hardware devices, e.g., a central processing unit (CPU), one or more microcontrollers, an application specific integrated circuit (ASIC), etc. The one or more processors 310 may comprise multiple processors including one or more general-purpose/application processors 330, one or more Digital Signal Processors (DSP) 331, one or more modem processors 332, one or more video processors 333, and/or one or more sensor processors 334. For example, the sensor processor 334 may comprise, e.g., processors for RF (radio frequency) sensing (with one or more wireless signals transmitted and reflection(s) used to identify, map, and/or track an object), and/or ultrasound, etc. The one or more modem processors 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 280 for connectivity. The one or more memories 311 may be one or more non-transitory storage media that may include random access memory (RAM), flash memory, disc memory, and/or read-only memory (ROM), etc. The one or more memories 311 may store the software 312 which may be processor-readable, processor-executable software code containing instructions that may be configured to, when executed, cause the one or more processors 310 to perform various functions described herein. Alternatively, the software 312 may not be directly executable by the one or more processors 310 but may be configured to cause the one or more processors 310, e.g., when compiled and executed, to perform the functions. The description herein may refer to the one or more processors 310 performing a function, but this includes other implementations such as where the one or more processors 310 executes software and/or firmware. The description herein may refer to the one or more processors 210 performing a function as shorthand for one or more of the processors 330-334 performing the function. The description herein may refer to the UE 300 performing a function as shorthand for one or more appropriate components of the UE 300 performing the function. Functionality of the one or more processors 310 is discussed more fully below.

The configuration of the UE 300 shown in FIG. 3 is an example and not limiting of the disclosure, including the claims, and other configurations may be used. For example, an example configuration of the UE 300 includes one or more of the processors 330-334 of the one or more processors 310, the one or more memories 311, a wireless transceiver, and one or more of the sensor(s) 313, the user interface 316, the camera 318, and/or the PD 319.

The UE 300 may comprise the modem processor 332 that may be capable of performing baseband processing of signals received and down-converted by the transceiver 315. The modem processor 332 may perform baseband processing of signals to be upconverted for transmission by the transceiver 315. Also, or alternatively, baseband processing may be performed by the general-purpose/application processor 330 and/or the DSP 331. Other configurations, however, may be used to perform baseband processing.

The UE 300 may include the sensor(s) 313 that may include, for example, an Inertial Measurement Unit (IMU) 370, one or more magnetometers 371, and/or one or more environment sensors 372. The IMU 370 may comprise, for example, one or more accelerometers 373 (e.g., collectively responding to acceleration of the UE 280 in three dimensions) and/or one or more gyroscopes 374 (e.g., three-dimensional gyroscope(s)). The sensor(s) 313 may include the one or more magnetometers 371 (e.g., three-dimensional magnetometer(s)) to determine orientation (e.g., relative to magnetic north and/or true north) that may be used for any of a variety of purposes, e.g., to support one or more compass applications. The environment sensor(s) 372 may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the one or more memories 311 and processed by the DSP 331 and/or the general-purpose/application processor 330 in support of one or more applications such as, for example, applications directed to positioning and/or navigation operations. The sensor(s) 313 may comprise one or more of other various types of sensors such as one or more optical sensors, one or more weight sensors, and/or one or more radio frequency (RF) sensors, etc.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The sensor(s) 313 may be useful to determine whether the UE 300 is fixed (stationary) or mobile. For example, for relative positioning information, the sensors/IMU may be used to determine the angle and/or orientation of the other device with respect to the UE 300, etc.

The IMU 370 may be configured to provide measurements about a direction of motion and/or a speed of motion of the UE 300, which may be used in relative location determination. For example, the one or more accelerometers 373 and/or the one or more gyroscopes 374 of the IMU 370 may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference position of the UE 300 may be determined for a moment in time and measurements from the accelerometer(s) 373 and the gyroscope(s) 374 taken after this moment in time may be used (e.g., in dead reckoning) to determine present position of the UE 300 based on movement (direction and distance) of the UE 300 relative to the reference location.

The magnetometer(s) 371 may determine magnetic field strengths in different directions which may be used to determine orientation of the UE 300. For example, the orientation may be used to provide a digital compass for the UE 300. The magnetometer(s) may include a two-dimensional magnetometer configured to detect and provide indications of magnetic field strength in two orthogonal dimensions. The magnetometer(s) 371 may include a three-dimensional magnetometer configured to detect and provide indications of magnetic field strength in three orthogonal dimensions. The magnetometer(s) 371 may provide means for sensing a magnetic field and providing indications of the magnetic field, e.g., to the one or more processors 310.

The transceiver 315 may include a wireless transceiver 340 configured to communicate with other devices through wireless connections. For example, the wireless transceiver 340 may include a wireless transmitter 342 and a wireless receiver 344 coupled to an antenna 346 for transmitting and/or receiving wireless signals 348 and transducing signals from the wireless signals 348 to wired (e.g., electrical and/or optical) signals and from wired (e.g., electrical and/or optical) signals to the wireless signals 348. The wireless receiver 344 includes appropriate components (e.g., one or more amplifiers, one or more frequency filters, and an analog-to-digital converter). The wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals according to a variety of radio access technologies (RATs) such as IEEE 802.11 (including IEEE 802.11 az), WiFi®, WiFi® Direct (WiFi®-D), Bluetooth®, Ultra-Wide Band (UWB) (including 802.15.4), etc. A “radio”, as used herein, refers to a wireless transmitter and/or wireless receiver configured to communicate signals according to a specific RAT. The transceiver 215 may be communicatively coupled to the transceiver interface 314, e.g., by optical and/or electrical connection. The transceiver interface 314 may be at least partially integrated with the transceiver 315. The wireless transmitter 342, the wireless receiver 344, and/or the antenna 346 may include multiple transmitters, multiple receivers, and/or multiple antennas, respectively, for sending and/or receiving, respectively, appropriate signals.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the one or more memories 311 to be processed by DSP 331 and/or the general-purpose/application processor 330 in response to action from a user or a request from an application. Similarly, applications hosted on the UE 300 may store indications of analog and/or digital signals in the one or more memories 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also, or alternatively, the user interface 316 may comprise one or more touch sensors responsive to touching and/or pressure, e.g., on a keyboard and/or touch screen of the user interface 316.

The UE 300 may include the camera 318 for capturing still or moving imagery. The camera 318 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 330 and/or the DSP 331. Also, or alternatively, the video processor 333 may perform conditioning, encoding, compression, and/or manipulation of signals representing captured images. The video processor 333 may decode/decompress stored image data for presentation on a display device (not shown), e.g., of the user interface 316.

The position device (PD) 319 may be configured to determine a position of the UE 300, motion of the UE 300, and/or relative position of the UE 300, and/or time. The PD 319 may work in conjunction with the one or more processors 310 and the one or more memories 311 as appropriate to perform at least a portion of one or more positioning methods, although the description herein may refer to the PD 319 being configured to perform, or performing, in accordance with the positioning method(s). The PD 319 may also or alternatively be configured to determine location of the UE 300 using terrestrial-based signals (e.g., at least some of the wireless signals 348) for trilateration. The PD 319 may be configured to use one or more images from the camera 318 and image recognition combined with known locations of landmarks (e.g., natural landmarks such as mountains and/or artificial landmarks such as buildings, bridges, streets, etc.) to determine location of the UE 300. The PD 319 may be configured to determine a relative motion or orientation by the UE 300 by comparing multiple images captured by the camera 318 and tracking how a common “point of interest” within the images moves between images. The PD 319 may be configured to use one or more other techniques (e.g., relying on the UE's self-reported location (e.g., part of the UE's position beacon)) for determining the location of the UE 300, and may use a combination of techniques (e.g., satellite and terrestrial positioning signals) to determine the location of the UE 300. The PD 319 may include one or more of the sensors 313 (e.g., gyroscope(s), accelerometer(s), magnetometer(s), etc.) that may sense orientation and/or motion of the UE 300 and provide indications thereof that the one or more processors 310 (e.g., the general-purpose/application processor 330 and/or the DSP 331) may be configured to use to determine motion (e.g., a velocity vector and/or an acceleration vector) of the UE 300. The PD 319 may be configured to provide indications of uncertainty and/or error in the determined position and/or motion. Functionality of the PD 319 may be provided in a variety of manners and/or configurations, e.g., by the general-purpose/application processor 330, the transceiver 315, and/or another component of the UE 300, and may be provided by hardware, software, firmware, or various combinations thereof.

Positioning particle filter may be used for indoor navigation and positioning of a UE to create a probabilistic positioning model. With a positioning particle filter, a UE's location(s) or estimated locations may be represented by multiple particles. Each particle may represent a possible state or location of a UE 105. A combination of multiple particles (e.g., an average, a centroid, a mean, etc. with an error or confidence range that is derived from a combination of multiple particles) of a particle cloud may be considered at least one estimated location of a UE 105. Additionally or alternatively, one or more individual particles of multiple particles of a particle cloud may be considered at least one estimated location of a UE 105. In response to movement of the UE 105, particles may be propagated according to a probability distribution. Particles may be propagated in accordance with a probability distribution further along a corridor, around a corner, by branching at an intersection, by taking a portal (e.g., a stairway, an escalator, an elevator, etc.) to a different floor, or any combination thereof.

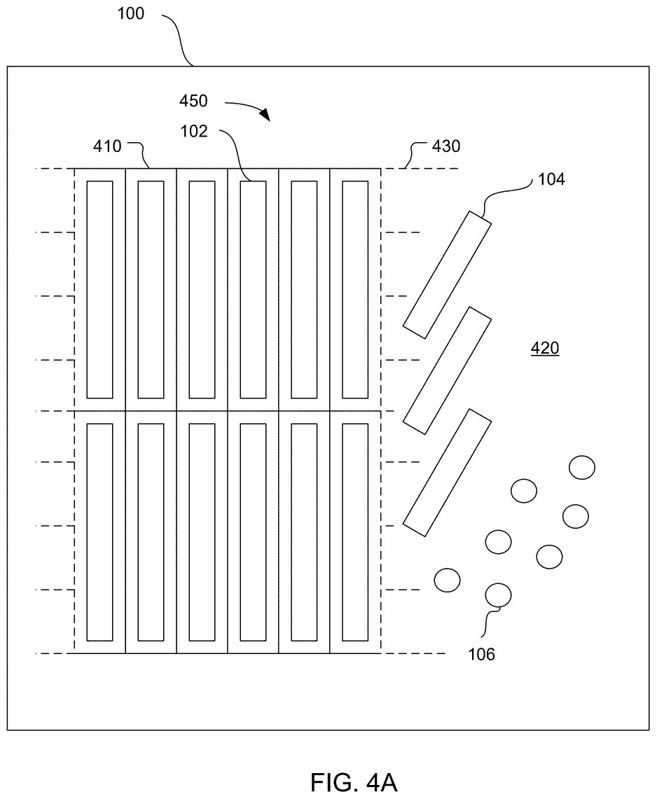

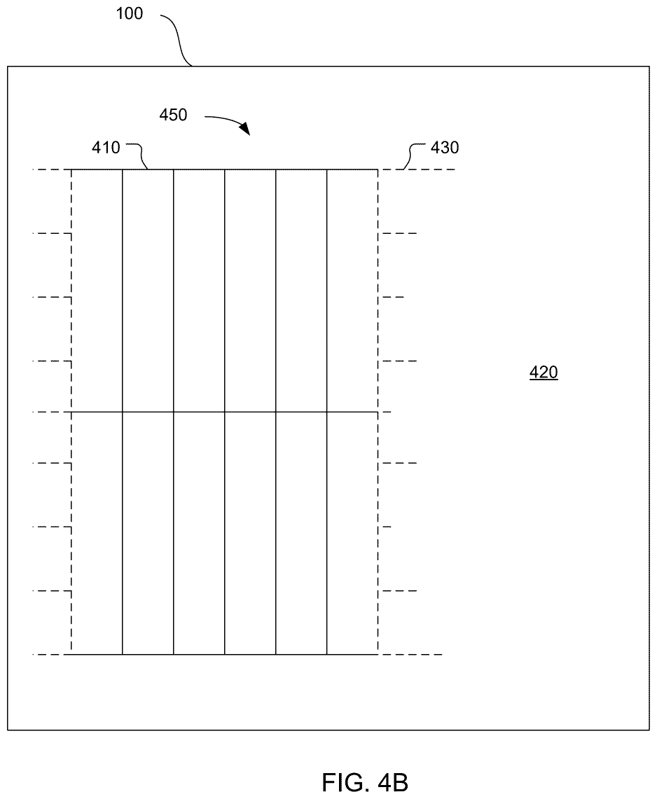

An indoor environment may be represented by a graph of path vectors of movement by a UE 105 derived from the floorplan for the indoor environment. The graph may be provided to the positioning engine 280 of the UE 105. For example, the graph may be included in the positioning assistance data provided by a network server. FIG. 4A illustrates an example graph 450 for the indoor environment 100 of FIG. 1, with the graph 450 overlaid on the floorplan for the indoor environment 100. FIG. 4B illustrates the example graph 450 without the overlay on the floorplan for the indoor environment 100. The graph 450 includes one or more edges 410, shown as solid lines, representing one or more pathways through one or more structured spaces. For example, due to the structured placements of obstacles (e.g., shelves 102 placed in a grid pattern), the UE 105 may travel in one dimension between the obstacles (e.g., one dimensional travel in the aisles between the shelves 102), where the one or more edges 410 may represent the one or more one-dimensional pathways through the obstacles. The graph 450 further includes one or more 2D planes 420 representing open pathways through spaces with less structure. For example, due to a mixture of placements of obstacles (e.g., a mixture of shelves 104 and displays 106 placed in a non-grid pattern), the possible pathways for the UE 105 may include travel in two dimensions, where the one or more 2D planes 420 may represent the one-or two-dimensional pathways through the mixture of obstacles. The graph 450 further includes one or more hybrid areas 430, shown as dotted lines, representing one or more one-or two-dimensional pathways through spaces between the one or more edges 410 and the 2D planes 420.

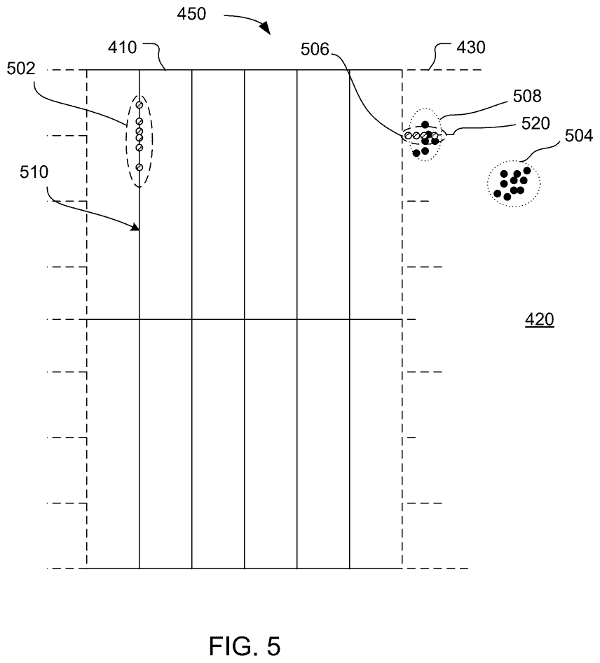

Referring to FIG. 5, in an example embodiment, a two-dimensional (2D) positioning particle filter allows particles 504 to move in two dimensions within the 2D planes 420. A one-dimensional (1D) positioning particle filter allows particles 502 to move in one dimension along the one or more edges 410. With the 1D positioning particle filter, particles may travel along directed or undirected edges 410. For example, if the edge 510 is an undirected edge, then the particles 502 may move in either direction along the edge 510. If the edge 510 is a directed edge, then the particles 502 may be restricted to travelling in only one direction along the edge 510. A combination of the 1D positioning particle filter and the 2D positioning particle filter allows particles 506, 508 to move in one dimension and/or two dimensions in the one or more hybrid areas 430. By reducing movement of the particles 502 in one dimension in structured spaces, causing the particles 502 to move more simply along the one or more edges 410 of the grid 450, the processing load to estimate the position of the UE 105 may be reduced due to savings in particle collision detection, as well as savings on more simplified propagation and position estimation than particle movements in two dimensions. Optionally, to further improve the performance of the position estimate, one or more hybrid areas 430 may be defined between the structured spaces represented by the edges 410 and the open spaces represented by the 2D plane 420, where particles 506, 508 are allowed to move in a combination of one and/or two dimensions, in order to smooth the transition between the 1D positioning particle filter and the 2D positioning particle filter.

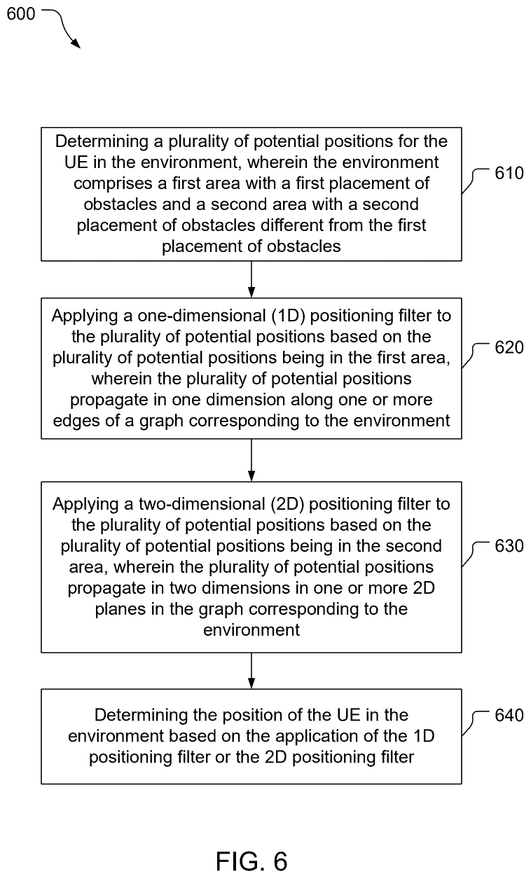

Referring to FIG. 6, with further reference to FIGS. 4A, 4B, and 5, a method 600 for determining a position of a UE in an environment includes the stages shown. The method 600 is, however, an example only and not limiting. The method 600 may be altered, e.g., by having one or more stages added, removed, rearranged, combined, performed concurrently, and/or by having one or more single stages split into multiple stages.

At stage 610, the method 600 includes determining a plurality of potential positions for the UE in the environment, wherein the environment comprises a first area with a first placement of obstacles and a second area with a second placement of obstacles different from the first placement of obstacles. For example, referring to FIGS. 4A and 4B, the environment may include an indoor environment 100 with a floorplan represented by the graph 450. The graph 450 may be included in assistance data provide to the UE 105 by a network server. The graph 450 may include one or more edges 410 representing one or more pathways through a first area with a first placement of obstacles, such as shelves 102, that form one or more structured spaces. The graph 450 includes one or more 2D planes 420 representing open pathways through a second area with a second placement of obstacles, such as a mixture of shelves 104 and displays 106, where the second placement of obstacles is different from the first placement of obstacles. For example, the difference between the first placement and the second placement may represent a floorplan where the obstacles in the first area are placed in a more structured manner than the obstacles in the second area, where a UE (e.g., UE 105) in the first area is more likely to move in one dimension than a UE in the second area and/or a UE in the second area is more likely to move in two dimensions than a UE in the first area. The one or more processors 210, possibly in combination with the one or more memories 211, may comprise means for determining a plurality of potential positions for the UE in the environment, wherein the environment comprises a first area with a first placement of obstacles and a second area with a second placement of obstacles different from the first placement of obstacles.

At stage 620, the method 600 includes applying a one-dimensional (1D) positioning filter to the plurality of potential positions based on the plurality of potential positions being in the first area, wherein the plurality of potential positions propagate in one dimension along one or more edges of a graph corresponding to the environment. For example, the 1D positioning filter may include a 1D positioning particle filter, where the particles propagate in one dimension. Referring to FIG. 5, a plurality of particles in a first particle cloud 502 may be placed along the edge 510 in the first area. In applying a 1D positioning particle filter, the particles in the first particle cloud 502 may propagate in one dimension along the edge 510 of the graph 450. If the edge 510 is an undirected edge, then the particles 502 may move in either direction along the edge 510. If the edge 510 is a directed edge, then the particles 502 may be restricted to travelling in only one direction along the edge 510. The one or more processors 210, possibly in combination with the one or more memories 211, may comprise means for applying a one-dimensional (1D) positioning filter to the plurality of potential positions based on the plurality of potential positions being in the first area, wherein the plurality of potential positions propagate in one dimension along one or more edges of a graph corresponding to the environment.

At stage 630, the method 600 includes applying a two-dimensional (2D) positioning filter to the plurality of potential positions based on the plurality of potential positions being in the second area, wherein the plurality of potential positions propagate in two dimensions in one or more 2D planes in the graph corresponding to the environment. For example, the 2D positioning filter may include a 2D positioning particle filter, where the particles propagate in two dimensions. Referring to FIG. 5, a plurality of particles in a second particle cloud 504 may be placed in one or more 2D planes 420. In applying a 2D positioning particle filter, the particles in the second particle cloud 504 propagate in two dimensions within the one or more 2D planes 420 of the graph 450. The one or more processors 210, possibly in combination with the one or more memories 211, may comprise means for applying a two-dimensional (2D) positioning filter to the plurality of potential positions based on the plurality of potential positions being in the second area, wherein the plurality of potential positions propagate in two dimensions in the graph corresponding to the environment.

At stage 640, the method 600 includes determining the position of the UE in the environment based on the application of the 1D positioning filter or the 2D positioning filter. For example, for particles in the first particle cloud 502 placed by the edge 510, the position of the UE 105 may be based on the application of the 1D positioning particle filter. For particles in the second particle cloud 504 placed in the 2D plane 420, the position of the UE 105 may be based on the application of the 2D positioning particle filter. The one or more processors 210, possibly in combination with the one or more memories 211, may comprise means for determining the position of the UE in the environment based on the application of the 1D positioning filter or the 2D positioning filter.

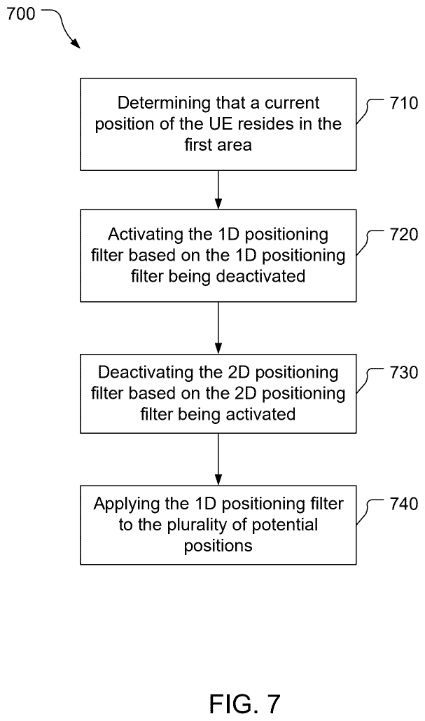

Implementations of the method 600 may include one or more of the following features. In an example implementation, based on the UE 105 moving into the first area, such as from the second area, the 1D positioning filter may be initiated or activated in order to determine the position of the UE 105. Referring to FIG. 7, with further reference to FIG. 5, a method 700 for determining a position of a UE in the first area of an environment includes the stages shown. The method 700 is, however, an example only and not limiting. The method 700 may be altered, e.g., by having one or more stages added, removed, rearranged, combined, performed concurrently, and/or by having one or more single stages split into multiple stages.

At stage 710, the method 700 may include determining that a current position of the UE resides in the first area. For example, a previous position of the UE 105 may reside in the second area, and a current position of the UE 105 may reside in the first area. The UE 105 may be determined to have moved from the second area to the first area based on the previous position being in the second area and the current position being in the first area. The one or more processors 210, possibly in combination with the one or more memories 211, may comprise means for determining that a current position of the UE resides in the first area.

At stage 720, the method 700 may include activating the 1D positioning filter based on the 1D positioning filter being deactivated. For example, based on the UE 105 moving to the first area, the 1D positioning filter may not be activated, and accordingly, the method 700 may initialize or activate the 1D positioning filter. For example, with reference to FIG. 5, the 1D positioning filter may include a 1D positioning particle filter, where a plurality of particles in a first particle cloud 502 may be initialized along an edge 510 and placed proximate to an initial estimated position of the UE 105 according to a standard deviation associated with the initial estimated position. Each particle in the first particle cloud 502 may be assigned (e.g., randomly assigned) a state that may include a position and an orientation, where the orientation may include a speed and a heading in one dimension along the edge 510. If the edge 510 is an undirected edge, then the heading may be in either direction along the edge 510. If the edge 510 is a directed edge, then the heading may be restricted to only one direction along the edge 510. Each given particle in the first particle cloud 502 may also be initialized with uniform weights, where the weight represents the probability that the UE 105 is in the state assigned to the given particle. The one or more processors 210, possibly in combination with the one or more memories 211, may comprise means for activating the 1D positioning filter based on the 1D positioning filter being deactivated.

At stage 730, the method 700 may include deactivating the 2D positioning filter based on the 2D positioning filter being activated. For example, when the UE 105 moves to the first area, the 2D positioning filter may be activated, and accordingly, the method 700 may deactivate the 2D positioning filter. The one or more processors 210, possibly in combination with the one or more memories 211, may comprise means for deactivating the 2D positioning filter based on the 2D positioning filter being activated.

At stage 740, the method 700 may include applying the 1D positioning filter to the plurality of potential positions. For example, with reference to FIG. 5, the 1D positioning filter may include a 1D positioning particle filter, where the 1D positioning particle filter is applied to the particles in the first particle cloud 502. The one or more processors 210, possibly in combination with the one or more memories 211, may comprise means for applying the 1D positioning filter to the plurality of potential positions.

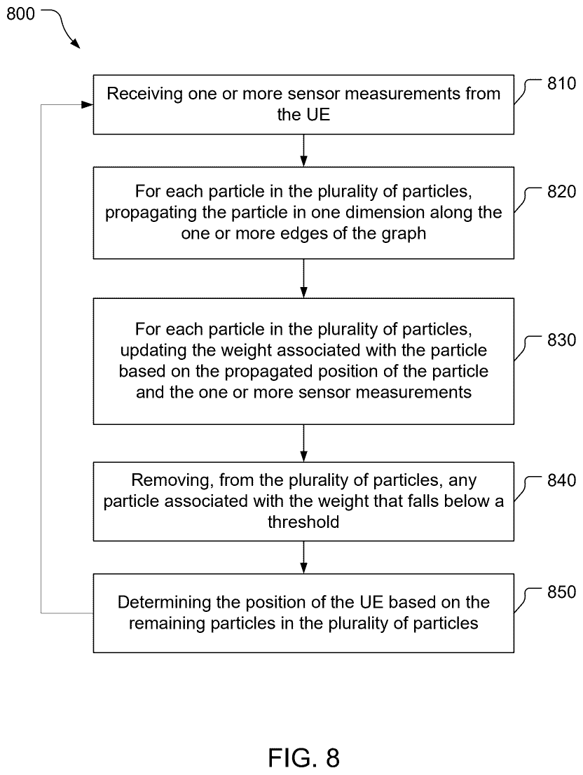

In an example implementation, the 1D positioning filter may include a 1D positioning particle filter. Referring to FIG. 8, with further reference to FIG. 5, a method 800 for applying the 1D positioning particle filter includes the stages shown. The method 800 is, however, an example only and not limiting. The method 800 may be altered, e.g., by having one or more stages added, removed, rearranged, combined, performed concurrently, and/or by having one or more single stages split into multiple stages.

At stage 810, the method 800 may include receiving one or more sensor measurements from the UE. For example, referring to FIG. 5, in the initialization of the 1D positioning particle filter, a plurality of particles in the first particle cloud 502 is placed proximate to an initial position of the UE 105 along an edge 510 of the graph 450 corresponding to the environment 100. Referring to FIG. 3, the one or more sensor measurements may include measurements of one or more RATs, such as signal strength or range measurements from the transceiver 315. The one or more sensor measurement may also include measurements from the one or more sensors 313. The one or more sensor measurements may provide a speed and heading for each particle in the first particle cloud 502 placed along the edge 510. The one or more processors 210, possibly in combination with the one or more memories 211, may comprise means for receiving one or more sensor measurements from the UE.

At stage 820, the method 800 may include, for each particle in the plurality of particles, propagating the particle in one dimension along the one or more edges of the graph. For example, each given particle in the first particle cloud 502 may be propagated in one dimension along the edge 510 based on the speed and heading of the given particle's state. The one or more processors 210, possibly in combination with the one or more memories 211, may comprise means for, for each particle in the plurality of particles, propagating the particle in one dimension along the one or more edges of the graph.

At stage 830, the method 800 may include, for each particle in the plurality of particles, updating the weight associated with the particle based on the propagated position of the particle and the one or more sensor measurements. For example, the weights of each given particle in the first particle cloud 502 may be modified based on the consistency between the propagated state of the given particle and the one or more sensor measurements. The less consistent the predicated state is compared to the one or more sensor measurements, the more the given particle's weight is reduced. For example, measurements from one or more inertial sensors indicate that the UE 105 has not moved while other sensor measurements indicate a relative turn angle of 90 degrees. However, the given particle may be propagated to move along the edge 510 and turn 90 degrees, and the weight of the given particle may be reduced based on the inconsistency between the measurements from the sensors and the propagated state of the given particle. The one or more processors 210, possibly in combination with the one or more memories 211, may comprise means for, for each particle in the plurality of particles, updating the weight associated with the particle based on the propagated position of the particle and the one or more sensor measurements.

At stage 840, the method 800 may include removing, from the plurality of particles, any particle associated with the weight that falls below a threshold. The threshold may represent the probability below which the position of the particle is considered unlikely to be the true position of the UE 105. For example, the threshold may be expressed as an absolute value, a proportion of a sum of the particles in the first particle cloud 502, or a proportion of the greatest weight in the first particle cloud 502 (i.e., a proportion of the weight of the heaviest particle in the first particle cloud 502). For example, if the modified weight of the given particle falls below the threshold, then the given particle may be removed from the first particle cloud 502. The one or more processors 210, possibly in combination with the one or more memories 211, may comprise means for removing, from the plurality of particles, any particle associated with the weight that falls below a threshold.

At stage 850, the method 800 may include determining the position of the UE based on the remaining particles in the plurality of particles. For example, the particle in the remaining particles with the greatest weight may be used to determine the estimated position of the UE 105 in the first area. Other techniques may be used to determine the position of the UE, such as positioning based on the distribution of the remaining particles in the plurality of particles. For example, in an area containing the remaining particles, the area may be divided into a grid pattern of cells (e.g., a grid of 10 cm×10 cm cells). A sum of the weights of the particles in each cell may be determined, and the cell with the largest sum may be used as the position of the UE 105. For another example, a 2D convolution may be performed on the grid cells using an n x n (e.g., 3×3 or 5×5) mask or matrix, where the maximum value from the convolution may be used as the position of the UE 105. The one or more processors 210, possibly in combination with the one or more memories 211, may comprise means for determining the position of the UE based on the remaining particles in the plurality of particles.

Stages 810 through 850 may be repeated with further sensor measurements from the UE 105. Optionally, if the number of particles remaining in the first particle cloud 502 falls below a certain threshold number required for accurate results, additional particles may be added to the sample and initialized for the next iteration of the method 800.

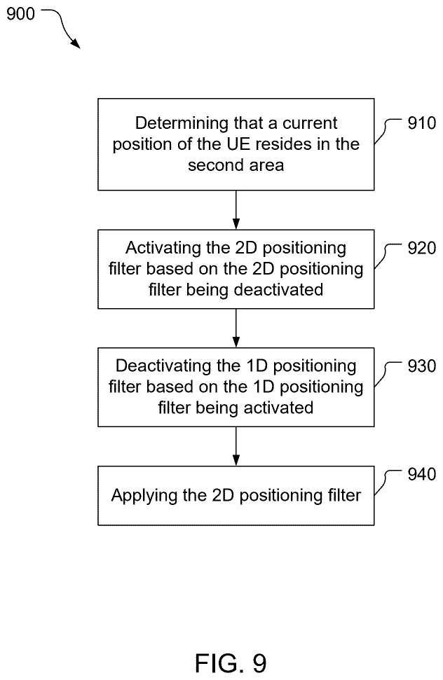

In another example implementation, based on the UE 105 moving into the second area, such as from the first area, the 2D positioning filter may be initiated or activated in order to determine the position of the UE 105. Referring to FIG. 9, with further reference to FIG. 5, a method 900 for determining a position of a UE in the second area of an environment includes the stages shown. The method 900 is, however, an example only and not limiting. The method 900 may be altered, e.g., by having one or more stages added, removed, rearranged, combined, performed concurrently, and/or by having one or more single stages split into multiple stages.

At stage 910, the method 900 may include determining that a current position of the UE resides in the second area. For example, a previous position of the UE 105 may reside in the first area, and a current position of the UE 105 may reside in the second area. The UE 105 may be determined to have moved from the first area to the first area based on the previous position being in the first area and the current position being in the second area. The one or more processors 210, possibly in combination with the one or more memories 211, may comprise means for determining that a current position of the UE resides in the second area.

At stage 920, the method 900 may include activating the 2D positioning filter based on 2D positioning filter being deactivated. For example, based on the UE 105 moving to the second area, the 2D ositioning filter may not be activated, and accordingly, the method 800 may initialize or activate the 2D ositioning filter. For example, with reference to FIG. 5, the 2D positioning filter may include a 2D positioning particle filter, where a plurality of particles in a second particle cloud 504 may be initialized in the 2D 420 and placed proximate to an initial estimated position of the UE 105 according to a standard deviation associated with the initial estimated position. Each particle in the second particle cloud 504 may be assigned (e.g., randomly assigned) a state that may include a position and an orientation, where the orientation may include a speed and a heading in two dimensions. Each given particle in the second particle cloud 504 may also be initialized with uniform weights, where the weight represents the probability that the UE 105 is in the state assigned to the given particle. The one or more processors 210, possibly in combination with the one or more memories 211, may comprise means for activating the 2D positioning filter based on the 2D positioning filter being deactivated.

At stage 930, the method 900 may include deactivating the 1D positioning filter based on the 1D positioning filter being activated. For example, based on the UE 105 moving to the second area, the 1D positioning filter may be activated, and accordingly, the method 800 may deactivate the 1D positioning filter. The one or more processors 210, possibly in combination with the one or more memories 211, may comprise means for deactivating the 1D positioning filter based on the 1D positioning filter being activated.

At stage 940, the method 900 may include applying the 2D positioning filter to the plurality of potential positions. For example, with reference to FIG. 5, the 2D positioning filter may include a 2D positioning particle filter, where the 2D positioning particle filter is applied to the particles in the second particle cloud 504. The one or more processors 210, possibly in combination with the one or more memories 211, may comprise means for applying the 2D positioning filter to the plurality of potential positions.

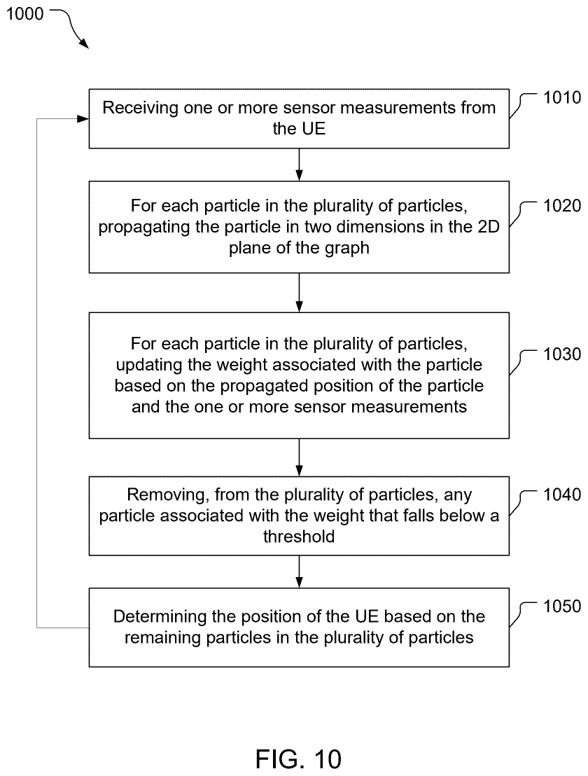

In an example implementation, the 2D positioning filter may include a 2D positioning particle filter. Referring to FIG. 10, with further reference to FIG. 5, a method 1000 for applying a 2D positioning particle filter includes the stages shown. The method 1000 is, however, an example only and not limiting. The method 1000 may be altered, e.g., by having one or more stages added, removed, rearranged, combined, performed concurrently, and/or by having one or more single stages split into multiple stages.

At stage 1010, the method 1000 includes receiving one or more sensor measurements from the UE. For example, referring to FIG. 5, in the initialization of the 2D positioning particle filter, a plurality of particles in the second particle cloud 504 is placed proximate to an initial position of the UE 105 in the 2D plane 420 of a graph 450 corresponding to the environment 100. Referring to FIG. 3, the one or more sensor measurements may include measurements of one or more RATs, such as signal strength or range measurements from the transceiver 315. The one or more sensor measurement may also include measurements from the one or more sensors 313. The one or more sensor measurements may provide a speed and heading for each particle in the second particle cloud 504 placed in the 2D plane 420. The one or more processors 210, possibly in combination with the one or more memories 211, may comprise means for receiving one or more sensor measurements from the UE.

At stage 1020, the method 1000 may include, for each particle in the plurality of particles, propagating the particle in two dimensions in the 2D plane of the graph. For example, each given particle in the second particle cloud 504 may be propagated in two dimensions in the 2D plane 420 based on the speed and heading of the given particle's state. The one or more processors 210, possibly in combination with the one or more memories 211, may comprise means for, for each particle in the plurality of particles, propagating the particle in two dimensions in the 2D plane of the graph.

At stage 1030, the method 1000 may include, for each particle in the plurality of particles, updating the weight associated with the particle based on the propagated position of the particle and the one or more sensor measurements. For example, the weights of each given particle in the second particle cloud 504 may be modified based on the consistency between the propagated state of the given particle and the one or more sensor measurements. The less consistent the predicated state is compared to the one or more sensor measurements, the more the given particle's weight is reduced. The one or more processors 210, possibly in combination with the one or more memories 211, may comprise means for, for each particle in the plurality of particles, updating the weight associated with the particle based on the propagated position of the particle and the one or more sensor measurements.

At stage 1040, the method 800 may include removing, from the plurality of particles, any particle associated with the weight that falls below a threshold. The threshold may represent the probability below which the position of the particle is considered unlikely to be the true position of the UE 105. For example, the threshold may be expressed as an absolute value, a proportion of a sum of the particles in the second particle cloud 504, or a proportion of the greatest weight in the second particle cloud 504 (i.e., a proportion of the weight of the heaviest particle in the second particle cloud 504). For example, if the modified weight of the given particle falls below the threshold, then the given particle may be removed from the second particle cloud 504. In an example implementation, a given particle with a propagated state that indicates that the given particle collides with an obstacle (e.g., obstacles 104 or 106) may be removed without the need to modify its weight. The one or more processors 210, possibly in combination with the one or more memories 211, may comprise means for removing, from the plurality of particles, any particle associated with the weight that falls below a threshold.

At stage 1050, the method 1000 may include determining the position of the UE based on the remaining particles in the plurality of particles. For example, the particle in the remaining particles with the greatest weight may be used as the estimated position of the UE 105 in the second area. Other techniques may be used to determine the position of the UE, such as positioning based on the distribution of the remaining particles in the plurality of particles. The one or more processors 210, possibly in combination with the one or more memories 211, may comprise means for determining the position of the UE based on the remaining particles in the plurality of particles.

Stages 1010 through 1050 may be repeated with further sensor measurements from the UE 105. Optionally, if the number of particles remaining in the second particle cloud 504 falls below a certain number required for accurate results, additional particles may be added to the sample and initialized for the next iteration of the method 1000.

Optionally, one or more hybrid areas between the first area and the second area may be defined in the graph corresponding to an environment, where potential positions of the UE 105 are allowed to move in a combination of one and two dimensions, in order to smooth the transition between the 1D positioning filter and the 2D positioning filter.

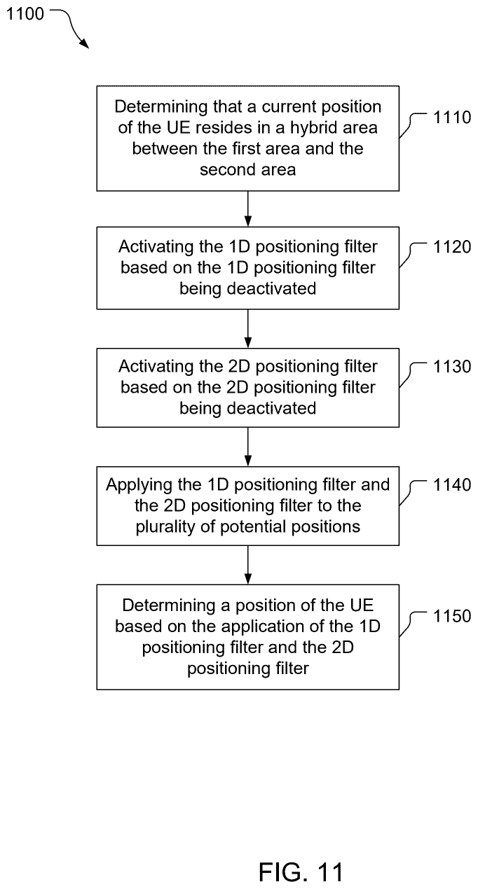

Referring to FIG. 11, with further reference to FIG. 5, a method 1100 for determining a position of a UE in an environment in the hybrid area includes the stages shown. The method 1100 is, however, an example only and not limiting. The method 1100 may be altered, e.g., by having one or more stages added, removed, rearranged, combined, performed concurrently, and/or by having one or more single stages split into multiple stages.

At stage 1110, the method 1100 may include determining that a current position of the UE resides in a hybrid area between the first area and the second area. For example, referring to FIG. 5, a current position of the UE 105 may reside in the hybrid area 430 between the one or more edges 410 and the one or more 2D planes 420. The one or more processors 210, possibly in combination with the one or more memories 211, may comprise means for determining that a current position of the UE resides in a hybrid area between the first area and the second area.

At stage 1120, the method 1100 may include activating the 1D positioning filter based on the 1D positioning filter being deactivated. For example, based on the UE 105 moving to the hybrid area 430, the 1D positioning filter may not be activated, and accordingly, the method 1100 may initialize or activate the 1D positioning filter. For example, with reference to FIG. 5, the 1D positioning filter may include a 1D positioning particle filter, particles in a third particle cloud 506 may be initialized in the area along an edge 520 in the hybrid area 430 and placed proximate to an initial estimated position of the UE 105 according to a standard deviation associated with the initial estimated position. Each particle in the third particle cloud 506 may be assigned (e.g., randomly assigned) a state that may include a position and an orientation, where the orientation may include a speed and a heading in one dimension along the edge 520. Each given particle in the third particle cloud 506 may also be initialized with uniform weights, where the weight represents the probability that the UE 105 is in the state assigned to the given particle. The one or more processors 210, possibly in combination with the one or more memories 211, may comprise means for activating the 1D positioning filter based on the 1D positioning filter being deactivated.

At stage 1130, the method 1100 may include activating the 2D positioning filter based on the 2D positioning filter being deactivated. For example, based on the UE 105 moving to the hybrid area 430, the 2D positioning filter may not be activated, and accordingly, the method 1100 may initialize or activate the 2D positioning filter. For example, with reference to FIG. 5, the 2D positioning filter may include a 2D positioning particle filter, where particles in a fourth particle cloud 508 may be initialized in a 2D plane in the hybrid area 430 and placed proximate to an initial estimated position of the UE 105 according to a standard deviation associated with the initial estimated position. Each particle in the fourth particle cloud 508 may be assigned (e.g., randomly assigned) a state that may include a position and an orientation, where the orientation may include a speed and a heading in two dimensions. Each particle in the fourth particle cloud 508 may also be initialized with uniform weights, where the weight represents the probability that the UE 105 is in the state assigned to the particle. The one or more processors 210, possibly in combination with the one or more memories 211, may comprise means for activating the 2D positioning filter based on the 2D positioning filter being deactivated.

At stage 1140, the method 1100 may include applying the 1D positioning filter and the 2D positioning filter to the plurality of potential positions. For example, with reference to FIG. 5, the 1D positioning filter may include a 1D positioning particle filter, and the 2D positioning filter may include a 2D positioning particle filter. The 1D positioning particle filter is applied to the particles in the third particle cloud 506, and the 2D positioning particle filter is applied to the particles in the fourth particle cloud 508. The 1D positioning particle filter may be applied according to the method 800 (see FIG. 8), and the 2D positioning particle filter may be applied according to the method 1000 (see FIG. 10). The one or more processors 210, possibly in combination with the one or more memories 211, may comprise means for applying the 1D positioning filter and the 2D positioning filter to the plurality of potential positions.

At stage 1150, the method 1100 may include determining a position of the UE based on the application of the 1D positioning filter and the 2D positioning filter. For example, a first position of the UE may be determined based on the application of the 1D positioning filter, where the first position may be associated with a first confidence level. A second position of the UE may be determined based on the application of the 2D positioning filter, where the second position may be associated with a second confidence value. The method 1100 may determine the position of the UE 105 by selecting either the first position or the second position with the higher confidence level. For another example, the first position may be determined to be within a first distance from the first area 410. If the first distance is within a threshold distance, then the method 1100 selects the first position as the position of the UE 105. Otherwise, the method 1100 selects the second position as the position of the UE 105.

In an alternative embodiment, the first area 410 and the second area 420 may also be configured as hybrid areas, i.e., the entire indoor environment 100 may be configured as a single hybrid area. The position of the UE 105 may then be determined according to the method 1100 throughout the single hybrid area.

### Implementation Examples

Implementation examples are provided in the following numbered clauses.

Clause 1. A method for determining a position of a user equipment (UE) in an environment, comprising: determining a plurality of potential positions for the UE in the environment, wherein the environment comprises a first area with a first placement of obstacles and a second area with a second placement of obstacles different from the first placement of obstacles; applying a one-dimensional (1D) positioning filter to the plurality of potential positions based on the plurality of potential positions being in the first area, wherein the plurality of potential positions propagate in one dimension along one or more edges of a graph corresponding to the environment; applying a two-dimensional (2D) positioning filter to the plurality of potential positions based on the plurality of potential positions being in the second area, wherein the plurality of potential positions propagate in two dimensions in one or more 2D planes in the graph corresponding to the environment; and determining the position of the UE in the environment based on the application of the 1D positioning filter or the 2D positioning filter.

Clause 2. The method of clause 1, wherein the applying of the 1D positioning filter comprises: determining that a current position of the UE resides in the first area; activating the 1D positioning filter based on the 1D positioning filter being deactivated; deactivating the 2D positioning filter based on the 2D positioning filter being activated; and applying the 1D positioning filter to the plurality of potential positions.

Clause 3. The method of clause 1, wherein the 1D positioning filter comprises a 1D particle filter, wherein the applying of the 1D positioning filter and the determining of the position of the UE, comprise: receiving one or more sensor measurements from the UE; for each particle in the plurality of particles, propagating the particle in one dimension along the one or more edges of the graph; for each particle in the plurality of particles, updating the weight associated with the particle based on a propagated position of the particle and the one or more sensor measurements; removing, from the plurality of particles, any particle associated with the weight that falls below a threshold; and determining the position of the UE based on the remaining particles in the plurality of particles.

Clause 4. The method of clause 1, wherein the applying of the 2D positioning filter comprises: determining that a current position of the UE resides in the second area; deactivating the 1D positioning filter based on the 1D positioning filter being activated; activating the 2D positioning filter based on the 2D positioning filter being deactivated; and applying the 2D positioning filter to the plurality of potential positions.

Clause 5. The method of clause 1, wherein the 2D positioning filter comprises a 2D particle filter, wherein the applying of the 2D positioning filter and the determining of the position of the UE, comprise: receiving one or more sensor measurements from the UE; for each particle in the plurality of particles, propagating the particle in two dimensions in the 2D plane of the graph; for each particle in the plurality of particles, updating the weight associated with the particle based on a propagated position of the particle and the one or more sensor measurements; removing, from the plurality of particles, any particle associated with the weight that falls below a threshold; and determining the position of the UE based on the remaining particles in the plurality of particles.

Clause 6. The method of clause 1, wherein the applying of the 1D positioning filter and the applying of the 2D positioning filter comprise: determining that a current position of the UE resides in a hybrid area between the first area and the second area; activating the 1D positioning filter based on the 1D positioning filter being deactivated; activating the 2D positioning filter based on the 2D positioning filter being deactivated; and applying the 1D positioning filter and the 2D positioning filter to the plurality of potential positions.

Clause 7. The method of clause 6, further comprising: determining an updated position of the UE based on the application of the 1D positioning filter and the application of the 2D positioning filter to the plurality of potential positions.

Clause 8. The method of clause 1, wherein the one or more edges of the graph comprise one or more directional edges.

Clause 9. A user equipment (UE) for determining a position of the UE in an environment, comprising: one or more memories; and one or more processors communicatively coupled to the one or more memories, the one or more processors being configured to: determine a plurality of potential positions for the UE in the environment, wherein the environment comprises a first area with a first placement of obstacles and a second area with a second placement of obstacles different from the first placement of obstacles; apply a one-dimensional (1D) positioning filter to the plurality of potential positions based on the plurality of potential positions being in the first area, wherein the plurality of potential positions propagate in one dimension along one or more edges of a graph corresponding to the environment; apply a two-dimensional (2D) positioning filter to the plurality of potential positions based on the plurality of potential positions being in the second area, wherein the plurality of potential positions propagate in two dimensions in one or more 2D planes in the graph corresponding to the environment; and determine the position of the UE in the environment based on the application of the 1D positioning filter or the 2D positioning filter.

Clause 10. The UE of clause 9, wherein the one or more processors configured to apply the 1D positioning filter are further configured to: determine that a current position of the UE resides in the first area; activate the 1D positioning filter based on the 1D positioning filter being deactivated; deactivate the 2D positioning filter based on the 2D positioning filter being activated; and apply the 1D positioning filter to the plurality of potential positions.

Clause 11. The UE of clause 9, wherein the 1D positioning filter comprises a 1D particle filter, wherein the one or more processors configured to apply the 1D positioning filter and to determine the position of the UE are further configured to: receive one or more sensor measurements from the UE; for each particle in the plurality of particles, propagate the particle in one dimension along the one or more edges of the graph; for each particle in the plurality of particles, update the weight associated with the particle based on a propagated position of the particle and the one or more sensor measurements; remove, from the plurality of particles, any particle associated with the weight that falls below a threshold; and determine the position of the UE based on the remaining particles in the plurality of particles.

Clause 12. The UE of clause 9, wherein the one or more processors configured to apply the 2D positioning filter are further configured to: determine that a current position of the UE resides in the second area; deactivate the 1D positioning filter based on the 1D positioning filter being activated; activate the 2D positioning filter based on the 2D positioning filter being deactivated; and apply the 2D positioning filter to the plurality of potential positions.

Clause 13. The UE of clause 9, wherein the 2D positioning filter comprises a 2D particle filter, wherein the one or more processors configured to apply the 2D positioning filter and the determining of the position of the UE are further configured to: receive one or more sensor measurements from the UE; for each particle in the plurality of particles, propagate the particle in two dimensions in the 2D plane of the graph; for each particle in the plurality of particles, update the weight associated with the particle based on a propagated position of the particle and the one or more sensor measurements; remove, from the plurality of particles, any particle associated with the weight that falls below a threshold; and determine the position of the UE based on the remaining particles in the plurality of particles.

Clause 14. The UE of clause 9, wherein the one or more processors configured to apply the 1D positioning filter and the applying of the 2D positioning filter are further configured to: determine that a current position of the UE resides in a hybrid area between the first area and the second area; activate the 1D positioning filter based on the 1D positioning filter being deactivated; activate the 2D positioning filter based on the 2D positioning filter being deactivated; and apply the 1D positioning filter and the 2D positioning filter to the plurality of potential positions.

Clause 15. The UE of clause 14, wherein the one or more processors are further configured to: determine an updated position of the UE based on the application of the 1D positioning filter and the application of the 2D positioning filter to the plurality of potential positions.

Clause 16. The UE of clause 9, wherein the one or more edges of the graph comprise one or more directional edges.

Clause 17. A user equipment (UE) for determining a position of the UE in an environment, comprising: means for determining a plurality of potential positions for the UE in the environment, wherein the environment comprises a first area with a first placement of obstacles and a second area with a second placement of obstacles different from the first placement of obstacles; means for applying a one-dimensional (1D) positioning filter to the plurality of potential positions based on the plurality of potential positions being in the first area, wherein the plurality of potential positions propagate in one dimension along one or more edges of a graph corresponding to the environment; means for applying a two-dimensional (2D) positioning filter to the plurality of potential positions based on the plurality of potential positions being in the second area, wherein the plurality of potential positions propagate in two dimensions in one or more 2D planes in the graph corresponding to the environment; and means for determining the position of the UE in the environment based on the application of the 1D positioning filter or the 2D positioning filter.

Clause 18. The UE of clause 17, wherein the means for applying of the 1D positioning filter comprises: means for determining that a current position of the UE resides in the first area; means for activating the 1D positioning filter based on the 1D positioning filter being deactivated; means for deactivating the 2D positioning filter based on the 2D positioning filter being activated; and means for applying the 1D positioning filter to the plurality of potential positions.

Clause 19. The UE of clause 17, wherein the means for 1D positioning filter comprises a 1D particle filter, wherein the applying of the 1D positioning filter and the determining of the position of the UE, comprise: means for receiving one or more sensor measurements from the UE; means for, for each particle in the plurality of particles, propagating the particle in one dimension along the one or more edges of the graph; means for, for each particle in the plurality of particles, updating the weight associated with the particle based on a propagated position of the particle and the one or more sensor measurements; means for removing, from the plurality of particles, any particle associated with the weight that falls below a threshold; and means for determining the position of the UE based on the remaining particles in the plurality of particles.

Clause 20. The UE of clause 17, wherein the means for applying of the 2D positioning filter comprises: means for determining that a current position of the UE resides in the second area; means for deactivating the 1D positioning filter based on the 1D positioning filter being activated; means for activating the 2D positioning filter based on the 2D positioning filter being deactivated; and means for applying the 2D positioning filter to the plurality of potential positions.

Clause 21. The UE of clause 17, wherein the means for 2D positioning filter comprises a 2D particle filter, wherein the means for applying of the 2D positioning filter and the means for determining of the position of the UE, comprise: means for receiving one or more sensor measurements from the UE; means for, for each particle in the plurality of particles, propagating the particle in two dimensions in the 2D plane of the graph; means for, for each particle in the plurality of particles, updating the weight associated with the particle based on a propagated position of the particle and the one or more sensor measurements; means for removing, from the plurality of particles, any particle associated with the weight that falls below a threshold; and means for determining the position of the UE based on the remaining particles in the plurality of particles.

Clause 22. The UE of clause 17, wherein the means for applying of the 1D positioning filter and the applying of the 2D positioning filter comprise: means for determining that a current position of the UE resides in a hybrid area between the first area and the second area; means for activating the 1D positioning filter based on the 1D positioning filter being deactivated; means for activating the 2D positioning filter based on the 2D positioning filter being deactivated; and means for applying the 1D positioning filter and the 2D positioning filter to the plurality of potential positions.

Clause 23. The UE of clause 22, further comprising: means for determining an updated position of the UE based on the application of the 1D positioning filter and the application of the 2D positioning filter to the plurality of potential positions.

Clause 24. The UE of clause 17, wherein the one or more edges of the graph comprise one or more directional edges.

Clause 25. A non-transitory, processor-readable storage medium comprising processor-readable instructions for determining a position of a user equipment (UE) in an environment, the processor-readable instructions to cause one or more processors to: determine a plurality of potential positions for the UE in the environment, wherein the environment comprises a first area with a first placement of obstacles and a second area with a second placement of obstacles different from the first placement of obstacles; apply a one-dimensional (1D) positioning filter to the plurality of potential positions based on the plurality of potential positions being in the first area, wherein the plurality of potential positions propagate in one dimension along one or more edges of a graph corresponding to the environment; apply a two-dimensional (2D) positioning filter to the plurality of potential positions based on the plurality of potential positions being in the second area, wherein the plurality of potential positions propagate in two dimensions in one or more 2D planes in the graph corresponding to the environment; and determine the position of the UE in the environment based on the application of the 1D positioning filter or the 2D positioning filter.

Clause 26. The non-transitory, processor-readable storage medium of clause 25, wherein the processor-readable instructions to cause the one or more processors to apply the 1D positioning filter comprise processor-readable instructions to cause the one or more processors to: determine that a current position of the UE resides in the first area; activate the 1D positioning filter based on the 1D positioning filter being deactivated; deactivate the 2D positioning filter based on the 2D positioning filter being activated; and apply the 1D positioning filter to the plurality of potential positions.

Clause 27. The non-transitory, processor-readable storage medium of clause 25, wherein the 1D positioning filter comprises a 1D particle filter, wherein the processor-readable instructions to cause the one or more processors to apply the 1D positioning filter and to determine the position of the UE comprise processor-readable instructions to cause the one or more processors to: receive one or more sensor measurements from the UE; for each particle in the plurality of particles, propagate the particle in one dimension along the one or more edges of the graph; for each particle in the plurality of particles, update the weight associated with the particle based on a propagated position of the particle and the one or more sensor measurements; remove, from the plurality of particles, any particle associated with the weight that falls below a threshold; and determine the position of the UE based on the remaining particles in the plurality of particles.

Clause 28. The non-transitory, processor-readable storage medium of clause 9, wherein the processor-readable instructions to cause the one or more processors to apply the 2D positioning filter comprise processor-readable instructions to cause the one or more processors to: determine that a current position of the UE resides in the second area; deactivate the 1D positioning filter based on the 1D positioning filter being activated; activate the 2D positioning filter based on the 2D positioning filter being deactivated; and apply the 2D positioning filter to the plurality of potential positions.

Clause 29. The non-transitory, processor-readable storage medium of clause 25, wherein the 2D positioning filter comprises a 2D particle filter, wherein the processor-readable instructions to cause the one or more processors to apply the 2D positioning filter and the determining of the position of the UE comprise processor-readable instructions to cause the one or more processors to: receive one or more sensor measurements from the UE; for each particle in the plurality of particles, propagate the particle in two dimensions in the 2D plane of the graph; for each particle in the plurality of particles, update the weight associated with the particle based on a propagated position of the particle and the one or more sensor measurements; remove, from the plurality of particles, any particle associated with the weight that falls below a threshold; and determine the position of the UE based on the remaining particles in the plurality of particles.

Clause 30. The non-transitory, processor-readable storage medium of clause 25, wherein the processor-readable instructions to cause the one or more processors to apply the 1D positioning filter and the applying of the 2D positioning filter comprise processor-readable instructions to cause the one or more processors to: determine that a current position of the UE resides in a hybrid area between the first area and the second area; activate the 1D positioning filter based on the 1D positioning filter being deactivated; activate the 2D positioning filter based on the 2D positioning filter being deactivated; and apply the 1D positioning filter and the 2D positioning filter to the plurality of potential positions.

Clause 31. The non-transitory, processor-readable storage medium of clause 30, wherein the processor-readable instructions further cause the one or more processors to: determine an updated position of the UE based on the application of the 1D positioning filter and the application of the 2D positioning filter to the plurality of potential positions.

Clause 32. The non-transitory, processor-readable storage medium of clause 25, wherein the one or more edges of the graph comprise one or more directional edges.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

We claim:

1. A method for determining a position of a user equipment (UE) in an environment, comprising:
determining a plurality of potential positions for the UE in the environment, wherein the environment comprises a first area with a first placement of obstacles and a second area with a second placement of obstacles different from the first placement of obstacles;
applying a one-dimensional (1D) positioning filter to the plurality of potential positions based on the plurality of potential positions being in the first area, wherein the plurality of potential positions propagate in one dimension along one or more edges of a graph corresponding to the environment;
applying a two-dimensional (2D) positioning filter to the plurality of potential positions based on the plurality of potential positions being in the second area, wherein the plurality of potential positions propagate in two dimensions in one or more 2D planes in the graph corresponding to the environment; and
determining the position of the UE in the environment based on the application of the 1D positioning filter or the 2D positioning filter.

2. The method of claim 1, wherein the applying of the 1D positioning filter comprises:
determining that a current position of the UE resides in the first area;
activating the 1D positioning filter based on the 1D positioning filter being deactivated;
deactivating the 2D positioning filter based on the 2D positioning filter being activated; and
applying the 1D positioning filter to the plurality of potential positions.

3. The method of claim 1, wherein the 1D positioning filter comprises a 1D particle filter, wherein the applying of the 1D positioning filter and the determining of the position of the UE, comprise:
receiving one or more sensor measurements from the UE;
for each particle in the plurality of particles, propagating the particle in one dimension along the one or more edges of the graph;
for each particle in the plurality of particles, updating the weight associated with the particle based on a propagated position of the particle and the one or more sensor measurements;
removing, from the plurality of particles, any particle associated with the weight that falls below a threshold; and
determining the position of the UE based on the remaining particles in the plurality of particles.

4. The method of claim 1, wherein the applying of the 2D positioning filter comprises:
determining that a current position of the UE resides in the second area;
deactivating the 1D positioning filter based on the 1D positioning filter being activated;
activating the 2D positioning filter based on the 2D positioning filter being deactivated; and
applying the 2D positioning filter to the plurality of potential positions.

5. The method of claim 1, wherein the 2D positioning filter comprises a 2D particle filter, wherein the applying of the 2D positioning filter and the determining of the position of the UE, comprise:
receiving one or more sensor measurements from the UE;
for each particle in the plurality of particles, propagating the particle in two dimensions in the 2D plane of the graph;
for each particle in the plurality of particles, updating the weight associated with the particle based on a propagated position of the particle and the one or more sensor measurements;
removing, from the plurality of particles, any particle associated with the weight that falls below a threshold; and
determining the position of the UE based on the remaining particles in the plurality of particles.

6. The method of claim 1, wherein the applying of the 1D positioning filter and the applying of the 2D positioning filter comprise:
determining that a current position of the UE resides in a hybrid area between the first area and the second area;
activating the 1D positioning filter based on the 1D positioning filter being deactivated;
activating the 2D positioning filter based on the 2D positioning filter being deactivated; and
applying the 1D positioning filter and the 2D positioning filter to the plurality of potential positions.

7. The method of claim 6, further comprising:
determining an updated position of the UE based on the application of the 1D positioning filter and the application of the 2D positioning filter to the plurality of potential positions.

8. The method of claim 1, wherein the one or more edges of the graph comprise one or more directional edges.

9. A user equipment (UE) for determining a position of the UE in an environment, comprising:
one or more memories; and
one or more processors communicatively coupled to the one or more memories, the one or more processors being configured to:
determine a plurality of potential positions for the UE in the environment, wherein the environment comprises a first area with a first placement of obstacles and a second area with a second placement of obstacles different from the first placement of obstacles;
apply a one-dimensional (1D) positioning filter to the plurality of potential positions based on the plurality of potential positions being in the first area, wherein the plurality of potential positions propagate in one dimension along one or more edges of a graph corresponding to the environment;
apply a two-dimensional (2D) positioning filter to the plurality of potential positions based on the plurality of potential positions being in the second area, wherein the plurality of potential positions propagate in two dimensions in one or more 2D planes in the graph corresponding to the environment; and
determine the position of the UE in the environment based on the application of the 1D positioning filter or the 2D positioning filter.

10. The UE of claim 9, wherein the one or more processors configured to apply the 1D positioning filter are further configured to:
determine that a current position of the UE resides in the first area;
activate the 1D positioning filter based on the 1D positioning filter being deactivated;
deactivate the 2D positioning filter based on the 2D positioning filter being activated; and
apply the 1D positioning filter to the plurality of potential positions.

11. The UE of claim 9, wherein the 1D positioning filter comprises a 1D particle filter, wherein the one or more processors configured to apply the 1D positioning filter and to determine the position of the UE are further configured to:
receive one or more sensor measurements from the UE;
for each particle in the plurality of particles, propagate the particle in one dimension along the one or more edges of the graph;
for each particle in the plurality of particles, update the weight associated with the particle based on a propagated position of the particle and the one or more sensor measurements;
remove, from the plurality of particles, any particle associated with the weight that falls below a threshold; and
determine the position of the UE based on the remaining particles in the plurality of particles.

12. The UE of claim 9, wherein the one or more processors configured to apply the 2D positioning filter are further configured to:
determine that a current position of the UE resides in the second area;
deactivate the 1D positioning filter based on the 1D positioning filter being activated;
activate the 2D positioning filter based on the 2D positioning filter being deactivated; and
apply the 2D positioning filter to the plurality of potential positions.

13. The UE of claim 9, wherein the 2D positioning filter comprises a 2D particle filter, wherein the one or more processors configured to apply the 2D positioning filter and the determining of the position of the UE are further configured to:
receive one or more sensor measurements from the UE;
for each particle in the plurality of particles, propagate the particle in two dimensions in the 2D plane of the graph;
for each particle in the plurality of particles, update the weight associated with the particle based on a propagated position of the particle and the one or more sensor measurements;
remove, from the plurality of particles, any particle associated with the weight that falls below a threshold; and
determine the position of the UE based on the remaining particles in the plurality of particles.

14. The UE of claim 9, wherein the one or more processors configured to apply the 1D positioning filter and the applying of the 2D positioning filter are further configured to:
determine that a current position of the UE resides in a hybrid area between the first area and the second area;
activate the 1D positioning filter based on the 1D positioning filter being deactivated;
activate the 2D positioning filter based on the 2D positioning filter being deactivated; and
apply the 1D positioning filter and the 2D positioning filter to the plurality of potential positions.

15. The UE of claim 14, wherein the one or more processors are further configured to:
determine an updated position of the UE based on the application of the 1D positioning filter and the application of the 2D positioning filter to the plurality of potential positions.

16. The UE of claim 9, wherein the one or more edges of the graph comprise one or more directional edges.

17. A user equipment (UE) for determining a position of the UE in an environment, comprising:
means for determining a plurality of potential positions for the UE in the environment, wherein the environment comprises a first area with a first placement of obstacles and a second area with a second placement of obstacles different from the first placement of obstacles;
means for applying a one-dimensional (1D) positioning filter to the plurality of potential positions based on the plurality of potential positions being in the first area, wherein the plurality of potential positions propagate in one dimension along one or more edges of a graph corresponding to the environment;
means for applying a two-dimensional (2D) positioning filter to the plurality of potential positions based on the plurality of potential positions being in the second area, wherein the plurality of potential positions propagate in two dimensions in one or more 2D planes in the graph corresponding to the environment; and
means for determining the position of the UE in the environment based on the application of the 1D positioning filter or the 2D positioning filter.

18. The UE of claim 17, wherein the means for applying of the 1D positioning filter comprises:
means for determining that a current position of the UE resides in the first area;
means for activating the 1D positioning filter based on the 1D positioning filter being deactivated;
means for deactivating the 2D positioning filter based on the 2D positioning filter being activated; and
means for applying the 1D positioning filter to the plurality of potential positions.

19. The UE of claim 17, wherein the means for applying of the 2D positioning filter comprises:
means for determining that a current position of the UE resides in the second area;
means for deactivating the 1D positioning filter based on the 1D positioning filter being activated;
means for activating the 2D positioning filter based on the 2D positioning filter being deactivated; and
means for applying the 2D positioning filter to the plurality of potential positions.

20. The UE of claim 17, wherein the means for applying of the 1D positioning filter and the applying of the 2D positioning filter comprise:
means for determining that a current position of the UE resides in a hybrid area between the first area and the second area;
means for activating the 1D positioning filter based on the 1D positioning filter being deactivated;
means for activating the 2D positioning filter based on the 2D positioning filter being deactivated; and
means for applying the 1D positioning filter and the 2D positioning filter to the plurality of potential positions.
